(19) United States
(12) Patent Application Publication
(10) Pub. No.: US 2008/0082764 A1
(43) Pub. Date: Apr. 3, 2008

(54) MEMORY ACCESSING SYSTEM AND METHOD

(76) Inventors: Yi Feng Jang, Taishan Township (TW); Zhi-Jian Liang, Shanghai (CN); Hai-Ping Liu, Shanghai (CN)

Correspondence Address: LAW OFFICES OF LAI AND ASSOCIATES, P.C., 5800 RANCHESTER STE 200, HOUSTON, TX, 77036, US

(21) Appl. No.: 11/538,253

(22) Filed: Oct. 3, 2006

(51) Int. Cl. G06F 13/00

(52) U.S. Cl. 711/154

(57) ABSTRACT

A memory accessing system, including an internal memory, an external memory, a microprocessor and a controller, is provided. The internal memory is configured to have a program space with a first address range and a data space with a second address range, and the program space and the data space are for source codes and data storage respectively. The external memory is configured to have an external data space with a third address range for storing data, and the third address range covers the first and second address ranges. The microprocessor is configured to process the source codes and data. The controller is configured to control the access of the program space, data space and the external data space.

### FIELD OF THE INVENTION

The present invention relates to a memory accessing system and method, and more particularly to the system and method that accurately access memory blocks with overlapping addresses.

### BACKGROUND OF THE INVENTION

While developing a microcomputer system, how many spaces for a built-in memory are important issues. For example, if a 64 K byte memory is disposed in an 8051 chip, in actual use, the space required for a program only needs 10K byte. Other space of 54 K byte is wasted, and the chip size and manufacture cost are increased.

In order to efficiently utilize built-in memory spaces, a method for data and source codes sharing a memory is provided. The method uses software to configure memory spaces. The spaces which are not occupied by the source codes can be used to store data. Therefore, the built-in memory is divided into a program memory and a data memory based on different stored contents.

The 8051 chip can support the data memory of 64 K byte. However, if the data memory of 64 K byte is disposed in the chip, the data memory will occupy a big space in the chip, and the memory space will not be completely used. Therefore, a part of memories is disposed in the chip and the other memories can be disposed to the outside of the chip except. In another word, while designing the chip, too great memories may not be disposed. If expansion is necessary while in use, an external memory is connected to the outside of the chip. However, for an 8051 microprocessor, memories which are disposed in the chip or to the outside of the chip are contained in the memory address spaces of 64 K byte.

FIG. 1 discloses a conventional memory accessing system 100 that comprises a chip 110 and an external memory 120. The chip 110 includes a microprocessor 130, a multiplexer 140, a memory bus 150, a data memory bus 152, a program memory bus 154 and an internal memory 160. The internal memory 160 includes a program space 162 for storing source codes and a data space 164 for storing instructions. The multiplexer 140 integrates the data space bus 152 and the program memory bus 154 into the memory bus 150. The external memory 120 is for storing data and is divided into a first overlapping space 122, a second overlapping space 124 and a non-overlapping space 126. The first overlapping space 122 and the program space 162 have the same address range. The second overlapping space 124 and the data space 164 have the same address range. Therefore, if data which would like to be accessed is in the address range of the data space 164, the data space 164 is only selected for accessing and the second overlapping space 124 is wasted. Because the program space 162 is used to store source codes and the first overlapping space 122 is occupied by the program space 162, data accessing may not be performed.

Under the scheme as shown in FIG. 1, the address bus is shared by data accessing and the program space. If data codes are written into the program space 162 due to some error instructions generated by noise or interferences, the source codes may be broken. Because the first overlapping space 122 and the program space 162 have the same address, the microprocessor 130 may not recognize. The first overlapping space 122 is unable to access data. In other words, if data is stored in the first overlapping space 122, the source codes in the program space 162 may be changed. The system may not be normally operated. Under the circumstance, the space occupied by the first overlapping space 122 is wasted.

Therefore, a memory accessing system and method must be provided for sharing address ranges and stored contents do not interfere with each other.

### SUMMARY OF THE INVENTION

Accordingly, the present invention provides a memory accessing system and method to avoid data to be wrongly stored and to avoid memory spaces to be wasted.

In accordance with an aspect of the invention, a memory accessing system is provided. The memory accessing system includes an internal memory, an external memory, a microprocessor and a controller. The internal memory is configured to have a program space with a first address range and a data space with a second address range. The program space is for storing source codes and the data space is for storing data. The external memory is configured to have an external data space with a third address range. The external data space is for storing data. The third address range includes the first and the second address ranges. The microprocessor is for processing source codes and data. The controller is for controlling the access for the program space, the data space and the external data space.

In accordance with another aspect of the invention, a memory accessing system is provided. The memory accessing system includes an internal memory, an external memory, a microprocessor and a controller. The internal memory is configured to have a program space with a first address range for storing source codes. The external memory is configured to have an external data space with a second address range for storing data. The second address range includes the first address range. The microprocessor is for processing source codes and data. The controller includes a register for controlling the access for the program space and the external data space.

In accordance with a further aspect of the invention, a controller for controlling a memory accessing is provided. The controller is disposed in a microcomputer. The microcomputer includes an internal memory, an external memory and a microprocessor. The internal memory is configured to have a program space with a first address range for storing source codes and a data space with a second address range for storing data. The external memory is configured to have an external data space with a third address range for storing data. The third address range includes the first and the second address ranges. The controller is for controlling the access for the program space, the data space and the external data space.

In accordance with a further aspect of the invention, a method for accessing a memory system is provided. The memory system includes an internal memory and an external memory. The internal memory is configured to have a first address range for storing source codes and a second address range for storing data. The external memory is configured to have a third address range for storing data. The third address range includes the first and the second address ranges. The method includes steps as following: A microprocessor transmits a data accessing instruction to a controller. If the address of the data accessing instruction is in the first address range, the controller controls the microprocessor to access the external memory.

Other features and advantages of the present invention and variations thereof will become apparent from the following description, drawings, and claims.

### BRIEF DESCRIPTION OF THE DRAWINGS

FIG. 1 is a block diagram illustrating a conventional memory accessing system;

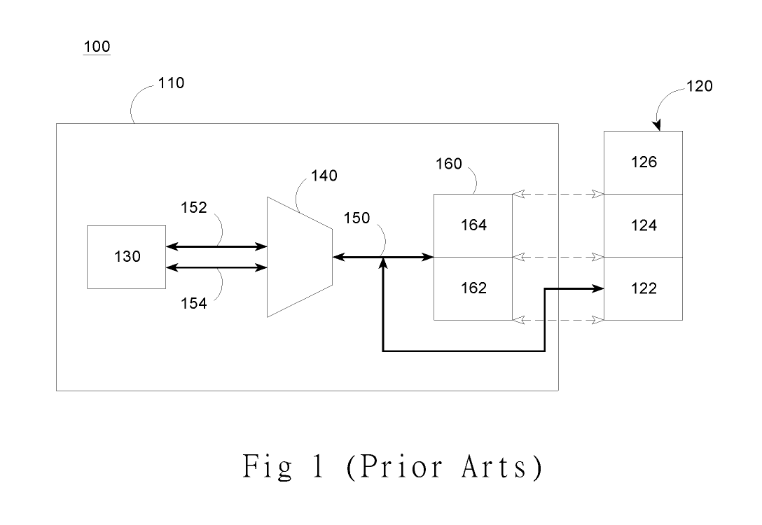

FIG. 2 is a block diagram illustrating a memory access system according to an embodiment of the present invention;

FIG. 3 is a block diagram illustrating a memory access system according to an embodiment of the present invention;

FIG. 4 is a block diagram illustrating a memory access system according to another embodiment of the present invention;

FIG. 5 is a schematic diagram illustrating a controller according to an embodiment of the present invention; and

FIG. 6 is a flowchart illustrating a method for accessing a memory according to an embodiment of the present invention.

### DETAILED DESCRIPTION OF THE PREFERRED EMBODIMENTS

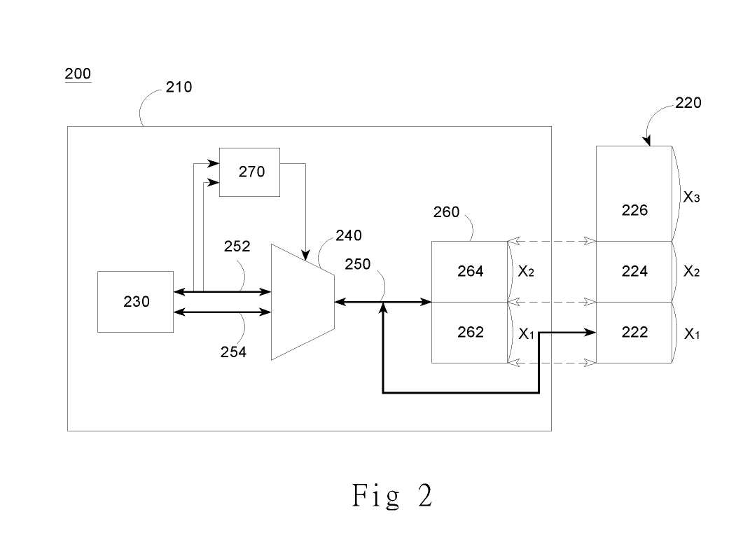

Referring to FIG. 2, a block diagram illustrates a memory accessing system 200 according to an embodiment of the present invention. The system 200 includes a chip 210 and an external memory 220. The chip 210 can be conventional single chips. The external memory 220 can be any storage device for storing data. The chip 210 includes a microprocessor 230, a multiplexer 240, a memory bus 250, a data memory bus 252, a program memory bus 254, an internal memory 260 and a controller 270. The internal memory 260 includes a program space 262 for storing source codes and a data space 264 for storing data. The address range of the program space 262 is X1. The address range of the data space 264 is X2. The multiplexer 240 integrates the data memory bus 252 and the program memory bus 254 into the memory bus 250. The memory bus 250 is connected to the internal memory 260 and the external memory 220. The controller 270 is for controlling paths of accessing data and source codes. The external memory 220 is divided into a first overlapping space 222, a second overlapping space 224 and a non-overlapping space 226. The first overlapping space 222 and the program space 262 have the same address range X1. The second overlapping space 224 and the data space 264 have the same address range X2.

The controller 270 could recognize the program space 262 of and the data space 264 of the internal memory 260. After differentiating, if the program space 262 needs to be accessed data, the controller 270 will not enable the microprocessor 230 to access the program space 262. Although the microprocessor 230 generates an error address, the controller 270 will not enable the microprocessor 230 to access data for the program space 262 either. Similarly, if the data space 264 needs to be accessed source codes, the controller 270 will not enable the microprocessor 230 to access the data space 264 either.

The external memory 220 and the internal memory 260 have overlapped address ranges. When the microprocessor 230 performs accessing the overlapped address ranges (X1, X2) for the external memory 220 and the internal memory 260, the controller 270 could recognize accessing the internal memory 260 or the external memory 220. In another word, the controller 270 could recognize five different spaces as shown in FIG. 2, including the program space 262, the data space 264, the first overlapping space 222, the second overlapping space 224 and the non-overlapping space 226.

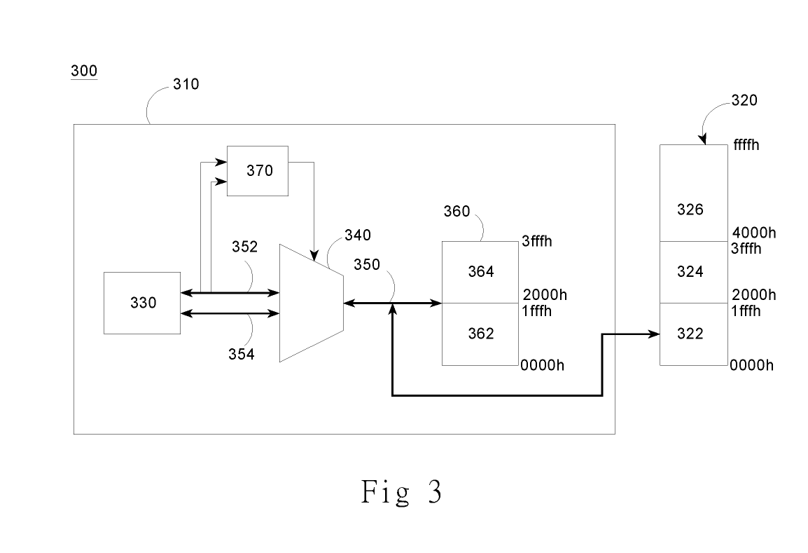

Referring to FIG. 3, a block diagram illustrates a memory accessing system 300 according to an embodiment of the present invention. The system 300 includes a chip 310 and an external memory 320. The address range of the external memory is from 0000h to ffffh. The chip 310 includes a microprocessor 330, a controller 370 and an internal memory 360. The accessing for the internal memory 360 and the external memory 320 is achieved through a data memory bus 352, a program memory bus 354, a multiplexer 340 and a memory bus 350. The internal memory 360 includes a program space 362 with an address range from 0000h to 1fffh and a data space 364 with an address range from 2000h to 3fffh. Therefore, the external memory 320 can be divided into a first overlapping space 322 with an address range from 0000h to 1fffh, a second overlapping space 324 with an address range from 2000h to 3fffh and a non-overlapping space 326 with an address range from 4000h to ffffh.

Because the controller 370 could recognize the program space 362 of and the data space 364 of the internal memory 360, the microprocessor 330 can access source codes from the program space 362 and can access data from the data space 364, the first overlapping space 322 and the non-overlapping space 326. For instance, if an instruction is used to move data into the space with address range from 0000h to 1fffh, data will be moved to the first overlapping space 322, not the program space 362, through the control of the controller 380. In addition, if an instruction is used to move data into the space with address range from 2000h to 3fffh, data can be selected to move to the data space 464 or the second overlapping space 324. In other words, one of characteristics of the invention is that both spaces with overlapped address ranges would not interfere with each other. The whole address range for accessing data is from 0000h to ffffh. The address range from 2000h to 3fffh is contained in the internal memory 360 and other range is contained in the external memory 320. The data space for use in the invention has 8 K byte more than the prior arts as the first overlapping space 322 with the address range 000h to 1fffh

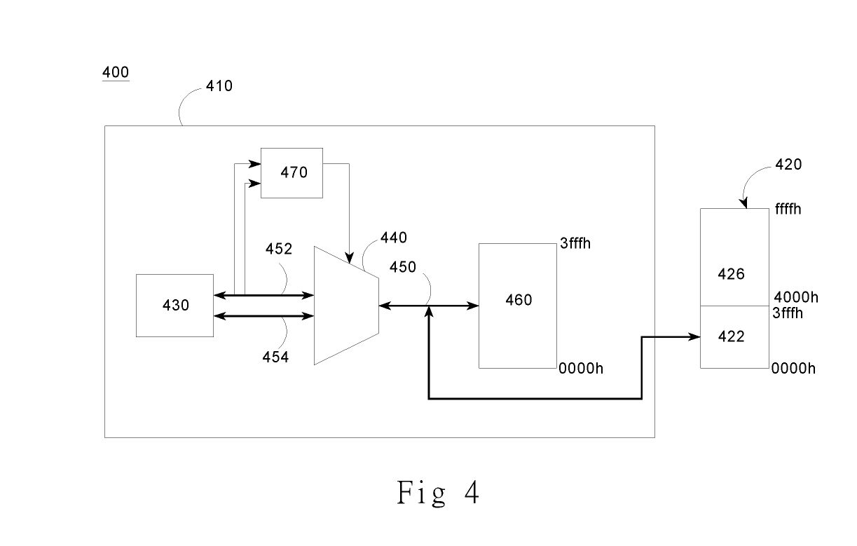

Referring to FIG. 4, a block diagram illustrates a memory accessing system 400 according to an embodiment of the present invention. The system 400 includes a chip 410 and an external memory 420. The address range of the external memory 420 is from 0000h to ffffh. The chip 410 includes a microprocessor 430, a controller 470 and an internal memory 460. The accessing for the internal memory 460 and the external memory 420 is achieved through a data memory bus 452, a program memory bus 454, a multiplexer 440 and a memory bus 450. In the embodiment, because spaces required for source codes are greater, the address range from 0000h to 3fffh for the internal memory 460 is configured to be the program space for storing source codes. Therefore, the external memory 420 can be divided into a first overlapping space 422 with an address range from 0000h to 3fffh and a non-overlapping space 426 with an address range from 4000h to ffffh. Because the controller 470 can recognize the internal memory 460 with the address range from 0000h to 3fffh for storing source codes, if the microprocessor 430 needs to access data in the address range from 0000h to 3fffh, the controller 470 performs accessing for the first overlapping space 422 without changing source codes in the internal memory 460. In another word, although the internal memory 460 and the first overlapping space 422 have overlapped address ranges, they would not interfere with each other. To compare with the prior arts, the space in the invention increases 16 K byte as the first overlapping space 422 with the address range from 0000h to 3fffh.

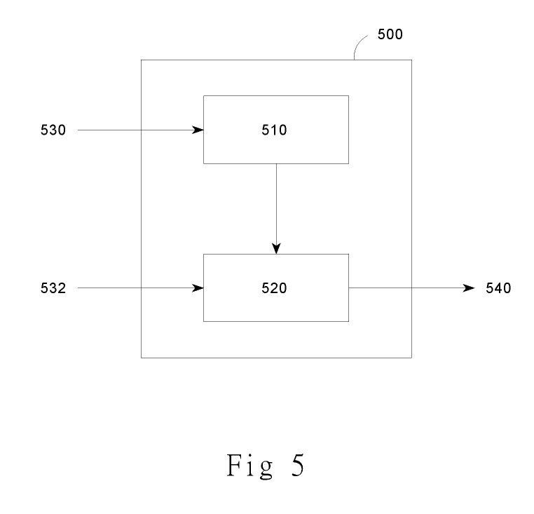

Referring to FIG. 5, a schematic diagram illustrates a controller 500 according to an embodiment of the present invention. The controller 500 includes a register 510 and a decoder 520. The microprocessor (e.g. the component 230 as shown in FIG. 2, the component 330 as shown in FIG. 3 and the component 430 as shown in FIG. 4) could perform reading and writing actions for the register 510 through instructions. The controller 500 receives program memory address of and data memory address of the microprocessor through a first input 530 and a second input 532. Next, the received program memory address and the received data memory address are compiled by values stored in the register 510 and the decoder 520 to generate control signals for controlling program memory bus and data memory bus. Lastly, the control signals are outputted from an output 540 and hardware can be controlled by the control signals. For example, the internal memory stores source codes to an address from 0000h. If 8K byte is needed for storing source codes, the internal memory is divided into two parts at 8 K byte when the register is controlled by firmware. Therefore, hardware can recognize the space of 8K byte with the address range from 0000h to 1fffh for storing source codes as shown FIG. 3. When the controller 500 controls hardware, the access for the internal memory and the external memory is completely separated and therefore mistakes may not occurred.

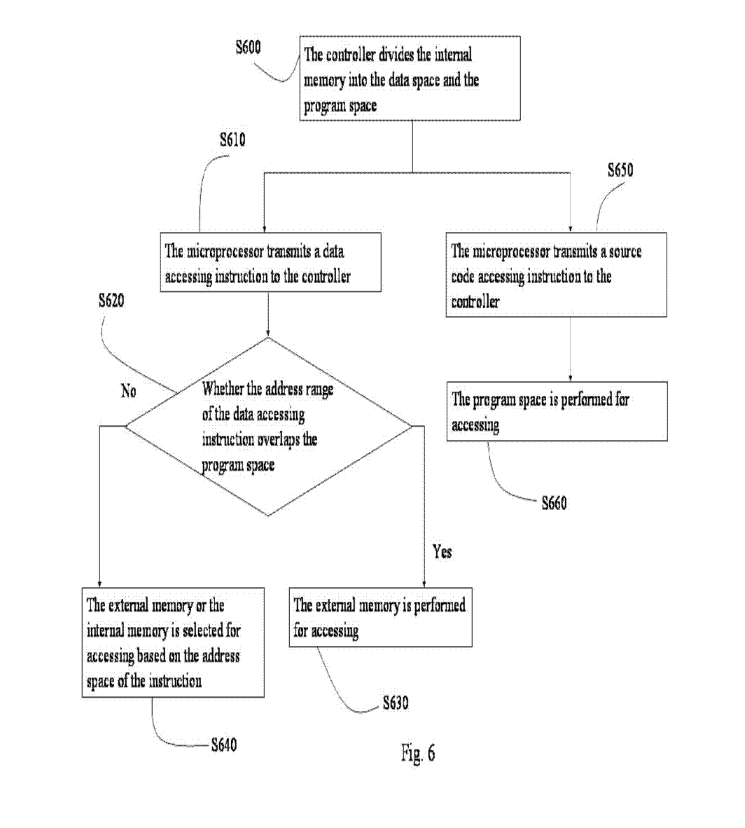

Referring to FIG. 6, a flowchart illustrates a method for accessing a memory system. Firstly, in step S600, the controller divides the space of the internal memory into the data space for storing data and the program space for storing source codes. If the microprocessor would like to access data, step S610 is performed. In step S610, the microprocessor transmits a data accessing instruction to the controller. Next, in step S620, the controller determines whether the address of the data accessing instruction is in the address range of the program space. If it is, step S630 is performed to access for the external memory. If the address of the data accessing instruction is not in the address range of the program space, step S640 is performed that which space is selected for accessing based on the address of the data accessing instruction. General Speaking, if the address of the instruction is not in the address range of the internal memory, the external memory is performed for accessing. If the address of the instruction is in the address range of the data space, the data space of the internal memory is performed for accessing. Alternately the external memory is performed for accessing. If the microprocessor would like to perform accessing for a source code, steps S600 to S650 are performed. In step S650, the microprocessor transmits a source code accessing instruction to the controller. Next, in step S660, the program space of the internal memory is performed for accessing.

The chip illustrated in the invention can be any conventional microprocessor chip, for example of a Z80 chip, a 6302 chip, a 8085 chip, a 80836 chip, a 8051 chip, a 8751 chip or a 8031 chip. The chip in the invention does not only include the microprocessor and the memory, but also includes conventional standard hardware components like a nonvolatile device (e.g. a hard disk drive), an input unit, an output unit or an Arithmetic and Logic Unit. Moreover, at least one microprocessor is contained. The aforementioned standard hardware components are not shown.

The microprocessor illustrated in the invention includes any processing device like a central processing unit and/or other processing circuits.

The memory illustrated in the invention includes a Random-Access Memory (RAM), a Static Random Access Memory (SRAM) and a Dynamic Random Access Memory (DRAM).

Although the features and advantages of the embodiments according to the preferred invention are disclosed, it is not limited to the embodiments described above, but encompasses any and all modifications and changes within the spirit and scope of the following claims.

What is claimed is:

1. A memory accessing system, comprising:
an internal memory configured to have a program space with a first address range and a data space with a second address range, said program space and said data space stored source codes and data respectively;
an external memory configured to have an external data space with a third address range, said external data space stored data, wherein said third address range includes said first address range and said second address range;
a microprocessor processed said source codes and said data; and
a controller controlled accessing of said program space, said data space and said external data space.

2. The memory accessing system of claim 1, wherein said controller has a register.

3. The memory accessing system of claim 1, wherein said external data space includes a first data space, a second data space and a third data space, wherein an address range of said first data space is the same as said first address range, and an address range of said second data space is the same as said second address range.

4. The memory accessing system of claim 1, wherein said microprocessor is controlled by said controller to obtain said source codes from said program space, and to access said data in said data space and said external data space.

5. The memory accessing system of claim 1, wherein said internal memory, said microprocessor and said controller are disposed in a chip, and said external memory is disposed to the outside of the said chip.

6. The memory accessing system of claim 1, further comprising a multiplexer for outputting a single memory bus to connect said internal memory and said external memory.

7. A memory accessing system, comprising:
an internal memory configured to have a program space with a first address range for storing source codes;
an external memory configured to have an external data space with a second address range for storing data, wherein said second address range includes said first address range;
a microprocessor processed said source codes and said data; and
a controller having a register for controlling the accessing of said program space and said external data space.

8. A controller disposed in a microcomputer system for controlling memory access, said microcomputer system comprising an internal memory, an external memory and a microprocessor,
wherein said internal memory is configured to have a program space with a first address range and a data space with a second address range for storing source codes and data respectively,
wherein said external memory is configured to have an external data space with a third address range for storing data, said third address range comprising said first address range and said second address range,
wherein said controller controls the accessing of said program space, said data space and said external data space.

9. The controller of claim 8, wherein said controller includes a register.

10. The controller of claim 8, wherein said external data space includes a first data space, a second data space, and a third data space, wherein an address range of said first data space is the same as said first address range, and an address range of said second data space is the same as said second address range.

11. The controller of claim 8, wherein said microprocessor is controlled by said controller to obtain source codes from said program space, and to access said data from said data space and said external data space.

12. The controller of claim 8, wherein said internal memory, said microprocessor and said controller are disposed in a chip, and said external memory is disposed to the outside of said chip.

13. The controller of claim 8, further comprising a multiplexer for outputting a single memory bus to connect said internal memory and said external memory.

14. A method for accessing a memory system, said memory system comprising an internal memory and an external memory, wherein said internal memory is configured to have a first address range for storing source codes and a second address range for storing data, and said external memory is configured to have a third address range for storing data, and said third address range includes said first address range and said second address range, said method comprising steps of:
transmitting a data accessing instruction to a controller from a microprocessor; and
controlling said microprocessor by said controller for accessing said external memory if an address of said data accessing instruction being in said first address range.

15. The method of claim 14, further comprising the step of:
transmitting a source code accessing instruction to said controller from said microprocessor; and controlling said microprocessor by said controller for accessing said first address range of said internal memory.

16. The method of claim 14, further comprising the step of providing a register to be contained in said controller.

17. The method of claim 14, further comprising the step of disposing said internal memory, said microprocessor and said controller in a chip, and disposing said external memory to the outside of said chip.
